(19) United States
(12) Patent Application Publication
(10) Pub. No.: US 2022/0329960 A1
(43) Pub. Date: Oct. 13, 2022

(54) AUDIO CAPTURE USING ROOM IMPULSE RESPONSES

(71) Applicant: Microsoft Technology Licensing, LLC, Redmond, WA (US)

(72) Inventors: Stav YAGEV, Tel Aviv (IL); Sharon KOUBI, Haifa (IL); Aviv HURVITZ, Tel Aviv (IL); Igor ABRAMOVSKI, Redmond, WA (US); Eyal KRUPKA, Shimshit (IL)

(21) Appl. No.: 17/229,688

(22) Filed: Apr. 13, 2021

(51) Int. Cl. H04S 7/00

(52) U.S. Cl. CPC H04S 7/302

(57) ABSTRACT

The disclosed technology is generally directed to audio capture. In one example of the technology, recorded sounds are received such that the sounds recorded were emitted from multiple locations in an environment and such that the sounds recorded are sounds that can be converted to room impulse responses. The room impulse responses are generated from the recorded sounds. Location information that is associated with the multiple locations is received. At least the room impulses responses and the location information are used to generate at least one environment-specific model. Audio captured in the environment is received. An output is generated by processing the captured audio with the at least one environment-specific model such that the output includes at least one adjustment of the captured audio based on at least one acoustical property of the environment.

### BACKGROUND

Typically, one of the biggest challenges for accurate automatic speech transcription and the capture of clean speech signals in enclosed spaces, is the acoustic settings where the recording device picks up the reverberations of speech signals from the room's walls and nearby objects, as well as any background noise. In the case of a meeting transcription, examples of relevant noise sources may include movement of items near the recording device, noise from neighboring spaces, noise from electronic equipment, etc. In some instances, a further challenge of conversational speech is simultaneous speech, wherein the captured speech signal is a composition of multiple speakers' contributions, and wherein each such contribution is characterized by a different pattern of acoustic reverberations.

### SUMMARY OF THE DISCLOSURE

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Briefly stated, the disclosed technology is generally directed to audio capture. In some examples, recorded sounds are received such that the sounds recorded were emitted from multiple locations in an environment and such that the sounds recorded are sounds that can be converted to room impulse responses (RIRs). In some examples, the room impulse responses are generated from the recorded sounds. In some examples, location information that is associated with the multiple locations is received. In some examples, at least the room impulses responses and the location information are used to generate at least one environment-specific model. In some examples, audio captured in the environment is received. In some examples, an output is generated by processing the captured audio with the at least one environment-specific model such that the output includes at least one adjustment of the captured audio based on at least one acoustical property of the environment.

Other aspects of and applications for the disclosed technology will be appreciated upon reading and understanding the attached figures and description.

### BRIEF DESCRIPTION OF THE DRAWINGS

Non-limiting and non-exhaustive examples of the present disclosure are described with reference to the following drawings. In the drawings, like reference numerals refer to like parts throughout the various figures unless otherwise specified. These drawings are not necessarily drawn to scale.

For a better understanding of the present disclosure, reference will be made to the following Detailed Description, which is to be read in association with the accompanying drawings, in which:

FIG. 1 is a block diagram illustrating one example of a suitable environment in which aspects of the technology may be employed;

FIG. 2 is a block diagram illustrating one example of a suitable computing device according to aspects of the disclosed technology;

FIG. 3 is a block diagram illustrating an example of a network-connected system;

FIG. 4 is a block diagram illustrating an example of a system for audio capture;

FIG. 5 is a block diagram illustrating an example of a system that may be an example of the system of FIG. 3 and/or FIG. 4; and

FIG. 6 is a flow diagram illustrating an example process for audio capture, in accordance with aspects of the present disclosure.

### DETAILED DESCRIPTION

The following description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The meaning of “in” includes “in” and “on.” The phrase “in one embodiment,” or “in one example,” as used herein does not necessarily refer to the same embodiment or example, although it may. Use of particular textual numeric designators does not imply the existence of lesser-valued numerical designators. For example, reciting “a widget selected from the group consisting of a third foo and a fourth bar” would not itself imply that there are at least three foo, nor that there are at least four bar, elements. References in the singular are made merely for clarity of reading and include plural references unless plural references are specifically excluded. The term “or” is an inclusive “or” operator unless specifically indicated otherwise. For example, the phrases “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The term “cloud” or “cloud computing” refers to shared pools of configurable computer system resources and higher-level services over a wide-area network, typically the Internet. “Edge” devices refer to devices that are not themselves part of the cloud, but are devices that serve as an entry point into enterprise or service provider core networks.

Briefly stated, the disclosed technology is generally directed to audio capture. In some examples, recorded sounds are received such that the sounds recorded were emitted from multiple locations in an environment and such that the sounds recorded are sounds that can be converted to room impulse responses. In some examples, the room impulse responses are generated from the recorded sounds. In some examples, location information that is associated with the multiple locations is received. In some examples, at least the room impulses responses and the location information are used to generate at least one environment-specific model. In some examples, audio captured in the environment is received. In some examples, an output is generated by processing the captured audio with the at least one environment-specific model such that the output includes at least one adjustment of the captured audio based on at least one acoustical property of the environment.

When audio is captured, various issues may prevent the audio from being heard clearly, particular in a context such as a meeting in a conference room. Audio that includes speech may be captured, for transmission of audio, for recording of the audio for later playback, and/or for transcription of speech in the audio, and it may be desirable that the speech in the captured audio be understood clearly, in spite of issues such as background noise, reverberation, and/or other issues.

Prior to capture of audio, such as prior to a meeting in environment (such as a room) in which audio is to be captured, a chirp noise may be emitted from multiple locations in the environment. For example, this may be accomplished by moving a device with a speaker to multiple locations in the environment and emitting a chirp from each location. In some examples, each time a chirp sound is emitted, the chirp sound is recorded, and a determination is made as to the location from which the chirp sound is emitted.

In some examples, the recorded chirp sounds, the information about the location from which each chirp sound was emitted, a generic model, and a pre-existing set of clean speech recordings are used to generate one or more models that are specific to the environment in which the chirps were emitted and recorded. The models may be, for example, noise suppression models, speech enhancement models, speech recognition models, and/or the like.

Generation of the environment-specific models may be accomplished by fine-tuning generic models for the environment based on room impulse responses (RIRs) generated from the recorded chirps, the location of the chirps when they were emitted, and the pre-existing clean speech recordings. The generic models may be models usable for any suitable location, generating by machine learning, but which are generic as to environment rather than being specific to a particular environment.

When audio is captured, the audio may be processed with the environment-specific models. The environment-specific models may improve the captured audio based on the specifics of the environments, such as by making speech in the captured audio easier to understand or causing the speech in the captured audio to be transcribed more accurately, in spite of issues in the environment such as reverberation, background noise, and/or other acoustic issues.

### Illustrative Devices/Operating Environments

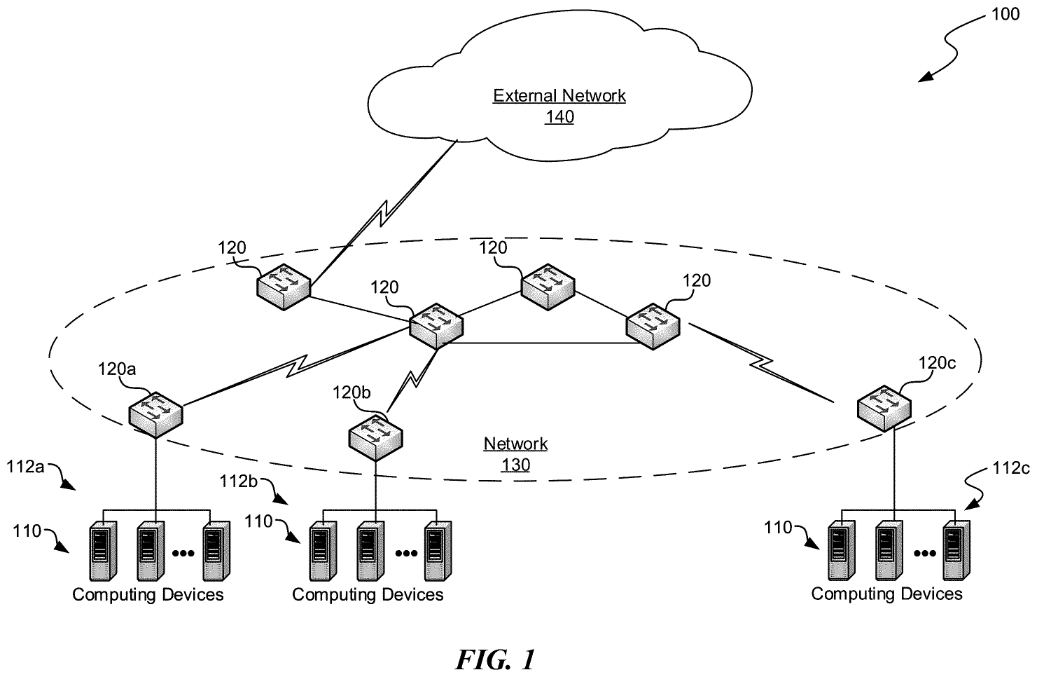

FIG. 1 is a diagram of environment 100 in which aspects of the technology may be practiced. As shown, environment 100 includes computing devices 110, as well as network nodes 120, connected via network 130. Even though particular components of environment 100 are shown in FIG. 1, in other examples, environment 100 can also include additional and/or different components. For example, in certain examples, the environment 100 can also include network storage devices, maintenance managers, and/or other suitable components (not shown). Computing devices 110 shown in FIG. 1 may be in various locations, including on premise, in the cloud, or the like. For example, computer devices 110 may be on the client side, on the server side, or the like.

As shown in FIG. 1, network 130 can include one or more network nodes 120 that interconnect multiple computing devices 110, and connect computing devices 110 to external network 140, e.g., the Internet or an intranet. For example, network nodes 120 may include switches, routers, hubs, network controllers, or other network elements. In certain examples, computing devices 110 can be organized into racks, action zones, groups, sets, or other suitable divisions. For example, in the illustrated example, computing devices 110 are grouped into three host sets identified individually as first, second, and third host sets 112a-112c. In the illustrated example, each of host sets 112a-112c is operatively coupled to a corresponding network node 120a-120c, respectively, which are commonly referred to as “top-of-rack” or “TOR” network nodes. TOR network nodes 120a-120c can then be operatively coupled to additional network nodes 120 to form a computer network in a hierarchical, flat, mesh, or other suitable types of topology that allows communications between computing devices 110 and external network 140. In other examples, multiple host sets 112a-112c may share a single network node 120. Computing devices 110 may be virtually any type of general- or specific-purpose computing device. For example, these computing devices may be user devices such as desktop computers, laptop computers, tablet computers, display devices, cameras, printers, or smartphones. However, in a data center environment, these computing devices may be server devices such as application server computers, virtual computing host computers, or file server computers. Moreover, computing devices 110 may be individually configured to provide computing, storage, and/or other suitable computing services.

In some examples, one or more of the computing devices 110 is a device that is configured to generate one or more environment-specific models and to capture audio with processing that uses the one or more environment-specific models.

### Illustrative Computing Device

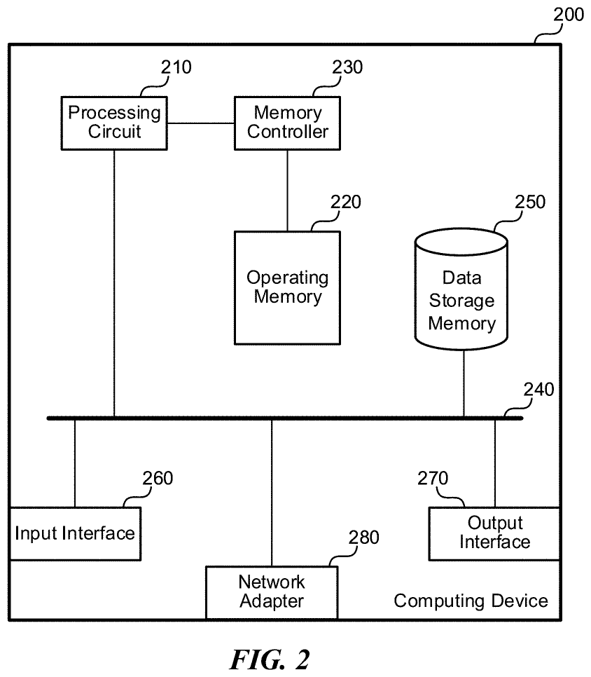

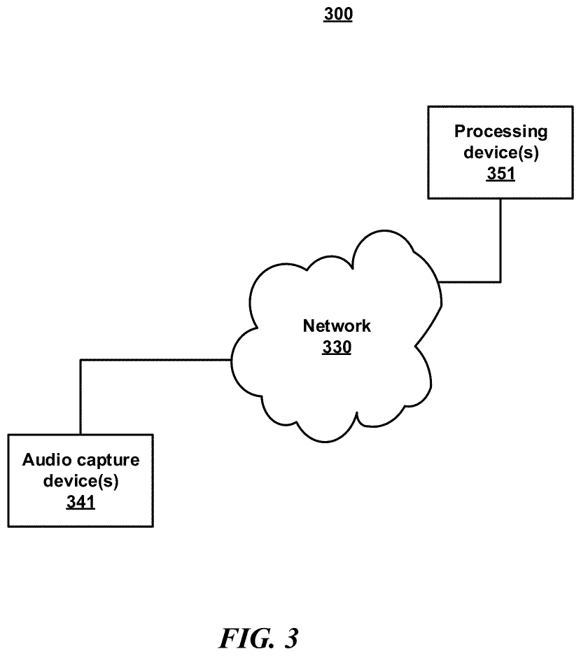

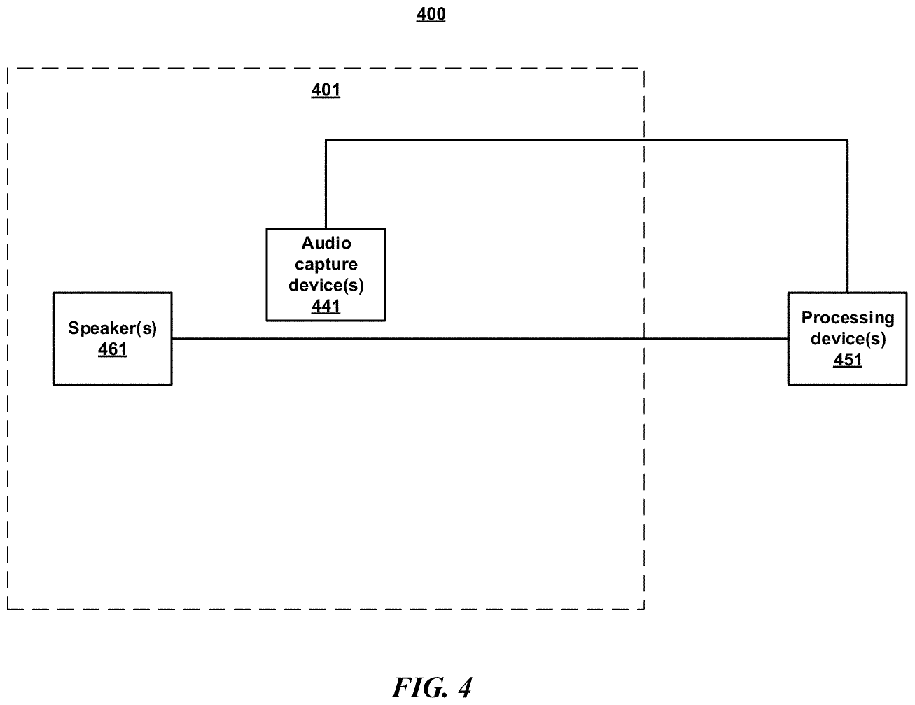

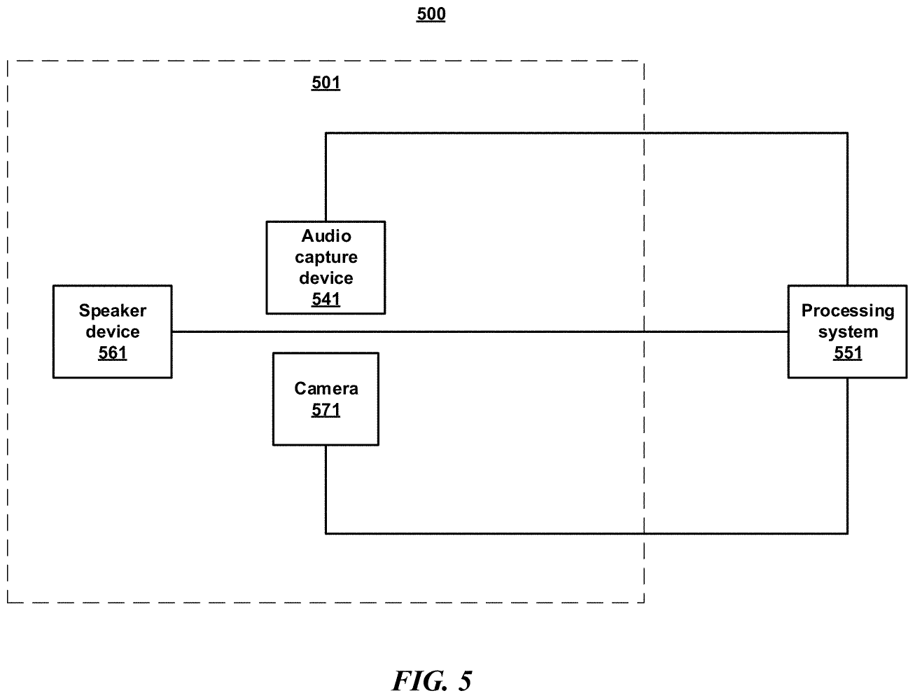

FIG. 2 is a diagram illustrating one example of computing device 200 in which aspects of the technology may be practiced. Computing device 200 may be virtually any type of general- or specific-purpose computing device. For example, computing device 200 may be a user device such as a desktop computer, a laptop computer, a tablet computer, a display device, a camera, a printer, or a smartphone. Likewise, computing device 200 may also be a server device such as an application server computer, a virtual computing host computer, or a file server computer, e.g., computing device 200 may be an example of computing device 110 or network node 120 of FIG. 1. Likewise, computer device 200 may be an example any of the devices, a device within any of the distributed systems, illustrated in or referred to in FIG. 3, FIG. 4, and/or FIG. 5, as discussed in greater detail below. As illustrated in FIG. 2, computing device 200 includes processing circuit 210, operating memory 220, memory controller 230, data storage memory 250, input interface 260, output interface 270, and network adapter 280. Each of these afore-listed components of computing device 200 includes at least one hardware element.

Computing device 200 includes at least one processing circuit 210 configured to execute instructions, such as instructions for implementing the herein-described workloads, processes, or technology. Processing circuit 210 may include a microprocessor, a microcontroller, a graphics processor, a coprocessor, a field-programmable gate array, a programmable logic device, a signal processor, or any other circuit suitable for processing data. The aforementioned instructions, along with other data (e.g., datasets, metadata, operating system instructions, etc.), may be stored in operating memory 220 during run-time of computing device 200. Operating memory 220 may also include any of a variety of data storage devices/components, such as volatile memories, semi-volatile memories, random access memories, static memories, caches, buffers, or other media used to store run-time information. In one example, operating memory 220 does not retain information when computing device 200 is powered off. Rather, computing device 200 may be configured to transfer instructions from a non-volatile data storage component (e.g., data storage component 250) to operating memory 220 as part of a booting or other loading process. In some examples, other forms of execution may be employed, such as execution directly from data storage component 250, e.g., eXecute In Place (XIP).

Operating memory 220 may include 4^{th} generation double data rate (DDR4) memory, 3^{rd} generation double data rate (DDR3) memory, other dynamic random access memory (DRAM), High Bandwidth Memory (HBM), Hybrid Memory Cube memory, 3D-stacked memory, static random access memory (SRAM), magnetoresistive random access memory (MRAM), pseudorandom random access memory (PSRAM), or other memory, and such memory may comprise one or more memory circuits integrated onto a DIMM, SIMM, SODIMM, Known Good Die (KGD), or other packaging. Such operating memory modules or devices may be organized according to channels, ranks, and banks. For example, operating memory devices may be coupled to processing circuit 210 via memory controller 230 in channels. One example of computing device 200 may include one or two DIMMs per channel, with one or two ranks per channel. Operating memory within a rank may operate with a shared clock, and shared address and command bus. Also, an operating memory device may be organized into several banks where a bank can be thought of as an array addressed by row and column. Based on such an organization of operating memory, physical addresses within the operating memory may be referred to by a tuple of channel, rank, bank, row, and column.

Despite the above-discussion, operating memory 220 specifically does not include or encompass communications media, any communications medium, or any signals per se.

Memory controller 230 is configured to interface processing circuit 210 to operating memory 220. For example, memory controller 230 may be configured to interface commands, addresses, and data between operating memory 220 and processing circuit 210. Memory controller 230 may also be configured to abstract or otherwise manage certain aspects of memory management from or for processing circuit 210. Although memory controller 230 is illustrated as single memory controller separate from processing circuit 210, in other examples, multiple memory controllers may be employed, memory controller(s) may be integrated with operating memory 220, or the like. Further, memory controller(s) may be integrated into processing circuit 210. These and other variations are possible.

In computing device 200, data storage memory 250, input interface 260, output interface 270, and network adapter 280 are interfaced to processing circuit 210 by bus 240. Although, FIG. 2 illustrates bus 240 as a single passive bus, other configurations, such as a collection of buses, a collection of point-to-point links, an input/output controller, a bridge, other interface circuitry, or any collection thereof may also be suitably employed for interfacing data storage memory 250, input interface 260, output interface 270, or network adapter 280 to processing circuit 210.

In computing device 200, data storage memory 250 is employed for long-term non-volatile data storage. Data storage memory 250 may include any of a variety of non-volatile data storage devices/components, such as non-volatile memories, disks, disk drives, hard drives, solid-state drives, or any other media that can be used for the non-volatile storage of information. However, data storage memory 250 specifically does not include or encompass communications media, any communications medium, or any signals per se. In contrast to operating memory 220, data storage memory 250 is employed by computing device 200 for non-volatile long-term data storage, instead of for run-time data storage.

Also, computing device 200 may include or be coupled to any type of processor-readable media such as processor-readable storage media (e.g., operating memory 220 and data storage memory 250) and communication media (e.g., communication signals and radio waves). While the term processor-readable storage media includes operating memory 220 and data storage memory 250, the term “processor-readable storage media,” throughout the specification and the claims whether used in the singular or the plural, is defined herein so that the term “processor-readable storage media” specifically excludes and does not encompass communications media, any communications medium, or any signals per se. However, the term “processor-readable storage media” does encompass processor cache, Random Access Memory (RAM), register memory, and/or the like.

Computing device 200 also includes input interface 260, which may be configured to enable computing device 200 to receive input from users or from other devices. In addition, computing device 200 includes output interface 270, which may be configured to provide output from computing device 200. In one example, output interface 270 includes a frame buffer, graphics processor, graphics processor or accelerator, and is configured to render displays for presentation on a separate visual display device (such as a monitor, projector, virtual computing client computer, etc.). In another example, output interface 270 includes a visual display device and is configured to render and present displays for viewing. In yet another example, input interface 260 and/or output interface 270 may include a universal asynchronous receiver/transmitter (UART), a Serial Peripheral Interface (SPI), Inter-Integrated Circuit (I2C), a General-purpose input/output (GPIO), and/or the like. Moreover, input interface 260 and/or output interface 270 may include or be interfaced to any number or type of peripherals.

In the illustrated example, computing device 200 is configured to communicate with other computing devices or entities via network adapter 280. Network adapter 280 may include a wired network adapter, e.g., an Ethernet adapter, a Token Ring adapter, or a Digital Subscriber Line (DSL) adapter. Network adapter 280 may also include a wireless network adapter, for example, a Wi-Fi adapter, a Bluetooth adapter, a ZigBee adapter, a Long-Term Evolution (LTE) adapter, SigFox, LoRa, Powerline, or a 5G adapter.

Although computing device 200 is illustrated with certain components configured in a particular arrangement, these components and arrangement are merely one example of a computing device in which the technology may be employed. In other examples, data storage memory 250, input interface 260, output interface 270, or network adapter 280 may be directly coupled to processing circuit 210, or be coupled to processing circuit 210 via an input/output controller, a bridge, or other interface circuitry. Other variations of the technology are possible.

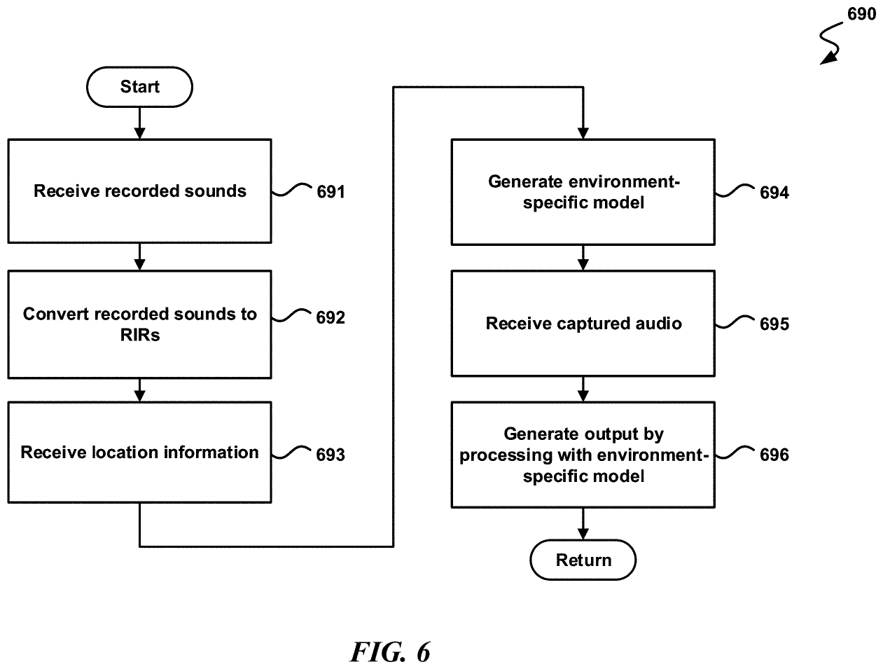

Some examples of computing device 200 include at least one memory (e.g., operating memory 220) adapted to store run-time data and at least one processor (e.g., processing unit 210) that is adapted to execute processor-executable code that, in response to execution, enables computing device 200 to perform actions, where the actions may include, in some examples, actions for one or more processes described herein, such as, in one example, process boo of FIG. 6, which is discussed in greater detail below.

### Illustrative System

FIG. 3 is a block diagram illustrating an example of a system (300). System 300 may include network 330, as well as audio capture device(s) 341 and processing device(s) 351, which, in some examples, all connect to network 330.

In some examples, audio capture device(s) 341 include one or more devices that are configured to record or otherwise capture audio. In some examples, audio capture device(s) 341 may include one or more encased microphone arrays. In other examples, audio capture device 341(s) may include other types of device(s) suitable for recording or otherwise capturing audio. The audio may include human speech. In some examples, audio capture device(s) 341 are connected, directly or indirectly, to network 330, so that captured audio may be communicated, via network 330, to processing device(s) 351.

In some examples, processing device(s) 351 are part or all of one or more distributed systems that are configured to perform one or more functions, including performing processing on captured audio. In some examples, processing devices(s) 351 may use at least recorded chirp sounds and information about the location from which each chirp sound was recorded to generate one or more models that are specific to the environment in which the chirps were emitted and recorded. In some examples, processing device(s) 351 may generate feedback associated with the environment, such as information associated with possible acoustic occlusions in the environment and/or other suitable feedback. In some examples, processing device(s) 351 may communicate the results of the feedback to audio capture device(s) 341 directly or indirectly over network 330.

Each of the devices in system 300 may include examples of computing device 200 of FIG. 2.

Network 330 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Network 330 may include various other networks such as one or more networks using local network protocols such as 6LoWPAN, ZigBee, or the like. In essence, network 330 includes any communication method by which information may travel among audio capture device(s) 341 and processing device(s) 351. Although each device is shown connected as connected to network 330, that does not mean that each device communicates with each other device shown. In some examples, some devices shown only communicate with some other devices/services shown via one or more intermediary devices. Also, although network 330 is illustrated as one network, in some examples, network 330 may instead include multiple networks that may or may not be connected with each other, with some of the devices shown communicating with each other through one network of the multiple networks and other of the devices shown communicating with each other with a different network of the multiple networks.

System 300 may include more or less devices than illustrated in FIG. 3, which is shown by way of example only.

In some examples, system 300 may include cloud devices in the cloud, and may also include edge devices. For instance, in some examples, processing device(s) 351 may be cloud devices in the cloud, and audio capture device(s) 341 may be edge devices. In some examples, system 300 may include further cloud devices and/or further edge devices.

In some examples, system 300 may further include one or more speakers, which may be edge devices in some examples. In some examples, speakers in system 300 may be used to emit chirp sounds. In some examples, system 300 may further include one or more cameras, which may be edge devices in some examples. In some examples, system 300 may include a camera, such as 360-degree camera. In some examples, when a chirp is emitted from a speaker, one or more cameras in system 300 may be used to assist in identifying the location from which the chirp was emitted.

FIG. 4 is a block diagram illustrating an example of a system (400). System 400 may be an example of system 300 of FIG. 3, or vice versa. System 400 may include environment 401, audio capture device(s) 441, processing device(s) 451, and speaker(s) 461.

Environment 401 may be any suitable environment in which audio is to be captured. In some examples, environment 401 may be a suitable enclosed indoor space, such as a conference room or the like. In other examples, environment 401 may be a space that is not an enclosed space, such as a porch or an outdoor environment.

Speaker(s) 461 may be used to generate sounds that can be converted to transfer functions. For instance, in some examples, the transfer functions may be room impulse responses. For instance, in some examples, speaker(s) 461 may be used to generate sounds that can converted to room impulses responses, such as chirping sounds. In some examples, speaker(s) 461 may include multiple stationary speakers, with each of the speakers being in a different location in environment 401. In other examples, speaker(s) 461 may instead be one device that includes hand-held speaker, where the device is moved to multiple locations in environment 401, and which emits a chirp sound (or other suitable sound that can be converted into a room impulse response) from each of these locations in environment 401. In some examples, each time a chirp sound is emitted from one of the speaker(s) 461, the chirp sound is recorded by audio capture device(s) 441, and a determination is made as to the location from which the chirp sound was emitted.

The determination of the location from which the chirp sound was emitted may be accomplished in different ways in different examples. In some examples, system 401 may include a camera that may be used to assist in the determination as to the location from which the chirp sound was emitted. In some examples, the camera may be a 360-degree panoramic camera. In some examples, a camera is not used, and the location is inferred from the chirp sound. For instance, in some examples, distance may be calculated based on the decibels emitted, the sensitivity of the microphones, and the decibels detected on microphones). In some examples, angle may be inferred based on the use of more than one microphone and measuring the difference in time for the sound to reach the different microphones to calculate the angle from which the sound is coming from. Other suitable methods of determining the location of the chirp sound may be used in various examples.

In some examples, the chirp sounds are played and captured one at a time, rather than playing multiple chirp sounds at the same time, so that each chirp sound emitted from a location in environment 401 may be captured cleanly without other chirp sounds, so that the captured chirp sounds may be properly and accurately converted into room impulse responses.

The captured chirp sounds and information about the location from which the chirp sounds were emitted may be transmitted to processing device(s) 451. Processing device(s) 451 may convert the chirp sounds to room impulse responses.

In some examples, an RIR is as follows. In these examples, an RIR is the output that would be recorded in a system if a Dirac delta function were emitted from the speakers. A Dirac delta function is mathematical function as opposed to a real-world sound—a Dirac delta function is zero at all points except t=0, and is a “perfect” pulse of infinitesimal duration. The RIR is the output that would be measured if such a Dirac delta function were emitted in a system, such as a room or other system. The “system” includes all relevant parts of a room or other space—the system includes the walls, obstacles, speakers, and microphones, which all have an effect on the RIR. A recorded chirp signal can be converted to the RIR of the system in which the signal was recorded by mathematical manipulation based on known mathematical techniques. For example, a recorded chirp signal can be converted to the RIR of the system by using fast Fourier transform and then dividing the complex spectra of the signals followed by an inverse fast Fourier transform. Other suitable mathematical techniques may also be used to convert the recorded chirp sound into the RIR of the system.

It may be possible to estimate, rather than calculate, the RIR of a system by various means. For example, an RIR may be estimated without recording sounds by assuming that the room, sound source, and receiver are ideal. It may also be possible to estimate the RIR of a system by recording a short impulsive high-energy sound such as a balloon pop, gun shot, or the like. It may also be possible to estimate the RIR of a system using a technique such as the Maximum Length Sequence technique, the Time Delay Spectrometry technique, or other technique. However, in some examples, by instead calculating the RIR of the system based on a recorded chirp sound or other sound from which the RIR can be calculated, the RIR can be calculated in an accurate manner.

In some examples, processing device(s) 451 may be used to generate at least one environment-specific model from the room impulse responses and the location information. In some examples, processing device(s) 451 may be used to generate at least one environment-specific model from the room impulse responses, the location information, the generic model, and pre-existing clean speech recordings.

The environment-specific models may include noise suppression models, speech enhancement models, speech recognition models, speech separation models, speech enhancement and separation models, and/or the like. In some examples, the environment-specific models may generated by: (1) generating an RIR database from the recorded chirp sounds and the location information, (2) generating acoustic scenarios from the RIR database and the clean speech recording, and then (3) generating the environment-specific models by fine-tuning generic models based on the acoustic scenarios.

In some examples, the RIR database contains numerous RIRs, each with its full set of metadata including information that is associated with source location, orientation, and room configuration, where the RIRs are generated by suitable mathematical manipulation of the recorded chirp signals. An RIR can be used to modify clean speech so that the modified speech sounds the way that the speech would as if the speech were being spoken in the system that was used to calculate the RIR. In some examples, the RIR database may be used to generate numerous combinations of challenging acoustical scenarios of overlapping speech in the specific environment by combining the RIR database with the clean speech recordings. In some examples, machine learning is used to train environment-specific models using the acoustical scenarios as training data to fine-tune the generic models by additional training of the generic models with the training data, but not training the environment-specific models from scratch. In some examples, generation of the generic models may involve a time period such as several weeks of training, whereas the generation of the environment-specific models may involve an hour of training or less since an existing generic model is being fine-tuned.

In some examples, generating the at least one environment-specific model may use the room impulse response and the location information, but may exclude one or both of the generic model and the pre-existing clean speech recordings. In some examples, the RIRs are analyzed to quantify the amount of typical reverberation, either per-location or in aggregate, in order to generate environment-specific parametrizations of well-known signal-processing algorithms, such as dereverberation. In other examples, if there are locations where there is a discrepancy between the sound-source-location (SSL) as estimated from the RIR and speaker(s) 461, then parametrization of the speaker attribution models are modified accordingly. Because many speaker-attribution processes estimate the SSL from the recorded signal and use the estimated SSL as the input to the process, a source-location which might be affected by occlusions may be determined to have SSL discrepancies that might become problematic.

In some examples, processing device(s) 451 may be used to generate feedback associated with environment 401, such as information associated with possible acoustic occlusions in the environment 401 and/or other suitable feedback.

In some examples, this feedback may be specific and actionable recommendations on how to improve the acoustic properties of environment 401 for subsequent audio capture. In some examples, the actionable recommendations may be that an object is occluding the microphones of audio capture device(s) 441 and that object should be moved. In some examples, the actionable recommendations may be that environment 401 should be covered with sound-absorption materials on the walls, floors, and/or ceiling.

In some examples, processing device(s) 451 may communicate to audio capture device(s) 441 the results of the processing, such as feedback and/or one or more environment-specific models. In some examples, some or all of the results of the processing, such as the feedback, may be communicated to the users in some manner other than communicating the results of the processing to audio capture devices(s) 441—for example, the feedback may instead be communication to users via email, via an app, or by other suitable means.

FIG. 5 is a block diagram illustrating an example of system 500. System 500 may be an example of system 300 of FIG. 3 and/or system 400 of FIG. 4. System 500 may include room 501, audio capture device 541, processing system 551, speaker device 561, and camera 571. Audio capture device 541, speaker device 561, and camera 571 may be situated in room 501. In some examples, room 501 is an example of environment 401 of FIG. 4, audio capture device 541 is an example of audio capture device(s) 441 of FIG. 4, and processing system 551 is an example of processing device(s) 451 of FIG. 4.

In some examples, processing system 551 is a cloud post-processing system that performs post processing in the cloud. In some examples, speaker device 561 is a hand-held speaker device. In some examples, camera 571 is a 360-degree panoramic camera. Although described as separate devices, some of the devices in system 501 may be included together in one device. For instance, in some examples, audio capture device 541 and camera 571 may be included together in one device.

In some examples, audio capture device 541 includes a microphone array. In some examples, audio capture device 541 includes an encased microphone array that is placed in a typical position in room 501, such as, for instance, in the middle of the table in the case of a meeting room. In some examples, one or more additional microphone arrays are also placed in room 501.

In some examples, camera 571 is mounted on audio capture device 541 in a fixed relative position. For instance, in some examples, audio capture device 541 has camera 571 mounted on top of a cone-shaped casing, with audio capture device 541 being a microphone array that is encased on the bottom of the cone.

In some examples, speaker device 561 is a hand-held mouth simulator that can be wirelessly powered and controlled by a computer running the controlling software, or controlled by controlling software running on speaker device 561 itself. In some examples, speaker device 561 is designed to simulate the acoustic properties of the human mouth. In some examples, speaker device 561 is designed to emit sounds of a significant portion of the audible range of frequencies, and is relatively flat in response, such that sounds at a particular frequency are not played at a quieter or louder volume than sounds of other frequencies.

In some examples, speaker device 561 is placed at several locations in room 501, to emit at least one chirp sound at each of these locations. In some examples, one chirp sound is emitted at each location. In some examples, two or more repeated chirp sounds are emitted at each location. In some examples, each of the locations is a position where human speakers are typically located. For instance, in some examples in which room 501 is a meeting room, the locations are positions and heights resembling human speakers sitting down near the table (e.g., above each chair, or above each position where is chair is expected to be located), standing near the whiteboard, and/or the like.

In some examples, each chirp sound is a sound that sweeps across a range of suitable audible frequencies exponentially with respect to time. In some examples, the sound may sweep across the dynamic range of speaker device 561. In some examples, during the calibration, each chirp sound emitted is substantially the same as each other chirp sound emitted during the calibration process.

In some examples, instead of being hand-held, speaker device 561 may be on a mobile motorized tripod. In some examples, the mobile motorized tripod may be moved by a robot.

In some examples, at each yaw and pitch rotation at which speaker device 561 is placed, the controlling software plays multiple identical sounds through speaker device 561. In some examples, each of the chirp sounds is recorded by audio capture device 541. In some examples, information about the location of speaker device 561 when the chirp is played through speaker device 561 is determined and communicated. The manner in which the location is determined may vary in different examples.

For instance, in some examples, a unique numeric identifier (ID), representing the specific position and rotation, is encoded in a tone sequence, and played through speaker device 561. In some examples, audio capture device 541 records both the chirp sound and the encoded ID. In some examples, camera 571 also records either an image or a video sequence that captures the relative location of the speaker device 561 with respect to audio capture device 541. In some examples, the recorded encoded ID and the image or video sequence captured by camera 571 may be used to determine, for each emitted chirp sound, the location of speaker device 561 when the chirp sound is emitted.

For instance, in some examples, the location and orientation of speaker device 561 is inferred from the image or video sequence. For instance, in some examples, the location and orientation of speaker device 561 is inferred from the image or video sequence based on automatic object detection for speaker device 561; face detection for the person holding speaker device 561; and/or manual image labeling. In some examples, the controlling software matches the recording of the chirp sounds to the respective physical locations of speaker device 561 by decoding the tone-encoded unique numeric ID.

In some examples, the chirp sound emissions are repeated for multiple configurations of the room. In some examples, each configuration is characterized by different room acoustics and therefore has a unique RIR pattern. Examples of different configurations that may be used include: various positions of the recording devices (including audio capture device 541 and any other recording devices being used); various locations of the speaker device 561 with respect to the recording devices; various arrangement of objects, such as laptops on a meeting-room table; and/or the like.

In some examples, ambient and transient noises are recorded on the recording devices to supplement the chirp recordings. In some examples, the noises are recorded with the same room acoustics as the chirp recordings. In the case of meetings, these noises may include the sound of moving things on the table, keyboard typing, coughing, and/or the like.

In some examples, the chirp recordings and any other recordings made along with the chirp recordings (such as noise recordings, encoded ID recordings, image or video recordings by camera 571, and/or the like) are communicated to processing system 551. In some examples, at least one processor in processing system 551 determines the RIR at each location using mathematical manipulation of the chirp recording. It is possible to estimate an RIR without recording sounds based on room parameters by assuming that the room, sound source, and receiver are ideal. However, by using one or more processors in processing system 551 to determine the RIR at each location by mathematical manipulation of a sound such as a chirp recording, generated in room 501, the RIR can be determined so that the RIR is specific to the real-world environment, including specific aspects of room 501 such as the sound absorption of different objects and materials, occlusions of the sound path, and/or the like.

In some examples, processing system 551 analyzes base noise levels during the recordings and certain properties of the resulting RIRs to verify that noise levels were low enough during the chirp in order to minimize the distortion such noise introduces in the recovery of the RIR. In some examples, three repeated chirps are made at each position, and for each position, processing system 551 compares the three repeated chirps. In some examples, a substantial difference between the repetitions indicates an interfering noise that invalidates the recording, and accordingly the invalidated recording is not used in the determination of the RIR.

In some examples, processing system 551 generates one or more of the followings outputs: (1) feedback, and/or (2) one or more room-specific models.

In some examples, the feedback includes a visual indication for the user on whether one or more devices in room 501, such as audio capture device 541, are optimally positioned within the room, for maximal accuracy of transcription and/or speech capture. In some examples, the feedback includes one or more actionable recommendations on the installation in room 501 to increase coverage and/or accuracy. For instance, in some examples, the actionable recommendations may include detection of installations which are too close to walls or other occlusions and a recommendation to keep enough space between them and audio capture device 541. In some examples, the actionable recommendations may include detection of unbalanced coverage and a recommendation to adjust the location of the one or more devices, such as audio capture device 541. In some examples, the actionable recommendations may include detection of insufficient coverage and a recommendation of adding another set of microphones in the edge locations.

The feedback may be determined in various manners in various examples. In some examples, various heuristics may be used on the chirp recordings to find problematic areas. For instance, in some examples, a difference in estimated angle from which sound is coming with the ground-truth angle may be used to indicate an acoustical issue, for example an acoustic occlusion or a specific point it the room with a significant amount of reverberation. A position in the room with such an issue may be marked with a red flag and indicated as a problematic position. In some examples, a map may be generated that includes an indication of positions that are determined to be problematic positions.

In some examples, after processing system 551 generates the feedback, the feedback is communicated to the user in some manner. In some examples, the feedback may be communicated to audio capture device 541, which the user can then view. In other examples, the feedback may be communicated to the user via email, via an app, and/or through some other suitable means.

In some examples, the one or more room-specific models may be models specific to room 501 such that usage of at least one of the room-specific models on audio captured from room 501 causes an adjustment of the captured audio based on at least one acoustical property of room 501. In some examples, the one or more room-specific models may include noise suppression models, speech enhancement models, speech recognition models, speech separation models, speech enhancement and separation models, and/or the like. In some examples, the one or more room-specific models may include an optimized speech enhancement and separation model, for use either on-device or in the cloud, customized for the specific installation, and optionally for the specific location of the speakers.

As discussed above, in some examples, processing system 551 generates one or more of the followings outputs: (1) feedback, and/or (2) one or more room-specific models. In some examples, in order to generate the outputs, processing system 551 first receives inputs, such as the chirp recordings, any other recordings made along with the chirp recordings (such as noise recordings, encoded ID recordings, image or video recordings by camera 571, and/or the like), and any other information that may be used to determine the locations from which each of the chirp sounds was emitted when it was recorded. In some examples, processing system 551 generates an RIR database containing RIRs from the chirp recordings.

In some examples, the RIR database contains numerous RIRs, each with its full set of metadata including information that is associated with source location, orientation, and room configuration. In some examples, the RIR database and one or more clean speech recordings is used to generate simulated speech signals, which accurately resemble the signals that would have been received given if a real person were talking in one of the sampled locations. The clean speech recordings may include many recordings of people saying a variety of utterances in a very controlled environment in which there is virtually no noise with a very high-quality microphone. The clean speech recordings may include, for instance, thousands of hours of recording of different people reading from textbooks, or the like. The clean speech recordings may be accompanied by transcriptions of the speech, in a format such that the transcriptions are relatively easy to associate to any simulated speech signals that are generated from the clean speech recordings.

In some examples, the RIR database is used to generate numerous combinations of challenging acoustical scenarios of overlapping speech in the specific environment. In some examples, RIR database may be used to generate the numerous combinations of challenging acoustical scenarios of overlapping speech in the specific environment by combining the RIR database with the clean speech recordings. In some examples, recorded noise recordings together with the RIR database are used to generate the scenarios. In some examples, the scenarios and pre-existing generic models may be used to generate the room-specific models.

In some examples, the generic models are previously generated using ML on data trained for a significant period of time, such as two weeks or more, using significant server resources. In some examples, the generic models are useful for many devices and many rooms, but are not fine-tuned to any specific room or environment. ML using scenarios generated based on the RIR database for room 501 may be used fine-tune the generic models in order to generate the room-specific models. The room-specific models may then be downloaded to the device that includes microphone array 441. In some examples, the scenarios generated by combining the RIR database with the clean speech recordings are used as training data to generate the one or more room-specific models as machine-learning (ML)-based speech enhancement algorithms that are generated by fine-tuning generic models that use ML-based algorithms. The generic algorithms may be algorithms that are generic as to location, which are fine-tuned to generate the room-specific models.

The generic models may be created based on a suitable method, such as by signal processing algorithms or by training deep neural networks on large datasets. For generic speech recognition models, the datasets used for training may include datasets in which recorded sound samples are paired with textual transcription of the sound samples. For generic speech enhancement and separation models, the datasets used for training may include noisy and mixed recordings of people talking at a distance from the microphone, each coupled with a high-quality recording from a microphone that is set up close to the mouths of the speakers. In some examples, the datasets used for training are simulated using clean speech recordings and sound simulation techniques.

In some examples, the training of the generic models uses ground truth labeling of the desired output, and in other examples, ground truth labeling is not used. In some examples, in the training of the generic models, one or more deep neural networks are trained to approximate the desired result from the input. For instance, in some examples of the generation of a speech separation and enhancement model, the input of the model includes a noisy multi-channel recording consisting of multiple speakers, and the output of the model includes multiple separate sound signals where each signal contains only a single speaker without noise. The inner structure of the generic model may include convolutional, recurrent, and/or transformer neural networks.

In some examples, the room-specific models may use a similar structure as the generic models as discussed above, with the room-specific models differing from the generic models by being trained on different data. For instance, generation of a room-specific speech separation and enhancement model may use a generic model that has been trained on data simulated in “ideal” rooms, with additional training used to fine-tune the generic model to generate the room-specific model. The additional training for the room-specific model may include further training with data that is based on the RIRs in the RIR database for the room. In some examples, the generic model's neural weights are used as a starting point in the training of the room-specific model. In some examples, when performing additional training to generate the room-specific model from the generic model, some layers of the network are changed based on the additional training, while some of the layers of the deep neural network are kept either unchanged or very slightly modified.

After the room-specific models are generated, audio may subsequently be captured in room 501, such as during a meeting, or other event in which audio is to be captured. The room-specific models may be used to process the audio. The audio may be captured for one or more purposes, for example to record audio for later playback, for speech transcription, and/or to transmit the audio, such as to one or more remote locations so that a conversation, meeting, talk, or the like may be held with one or more remote participants. In some examples, the one or more room-specific models may enable the recorded audio of simultaneous speakers to be separated such that each speaker's contribution is isolated to a separate audio stream. In various examples, the one or more room-specific models may enable the recorded audio, transmitted audio, and/or speech transcription to be cleaner, more accurate, and/or have the speech more clearly understood and/or accurately transcribed, in spite of issues such as background noise, acoustical issues of the room (including reverberations, the sound absorption of different objects and materials, occlusions of the sound path, simultaneous speaking, and/or the like).

In some examples, the processing performed by processing system 551 to generate the room specific models may take a fair amount of time, such as an hour or longer. Accordingly, in some examples, immediately before a meeting in which audio is to be captured, a final calibration may be performed by providing the chirps again and performing a final fine-tuning of the models based on room 501 as it is immediately prior to the meeting, so that the models can take into account things that have changed since the room-specific models were generated, such as the movement of objects in the room that may cause acoustical occlusions, windows may have been opened or closed, the specific location of audio capture device 541 may have changed, and/or the like.

In some examples, the audio may be captured in such a way that the audio is recorded for later playback, or the audio may be transmitted, in such a way that, using the room specific models, speech in the audio may be clearly understood in spite of issues such as background noise, acoustical issues of the room (including reverberations, the sound absorption of different objects and materials, occlusions of the sound path, simultaneous speaking, and/or the like).

In some examples, the audio is captured and speech in the captured audio is transcribed. In some examples, the transcription of speech includes, for any speech in the captured audio, an indication of which human speaker was talking. In some examples, when multiple people are talking simultaneously, the transcription includes an indication of each human speaker talking during the simultaneous speech, and what was said separately by each of the human speakers, even though the human speakers were speaking simultaneously. In some examples, using the room-specification models, speech is transcribed accurately and with an accurate indication of the human speakers, in spite of issues such as background noise, acoustical issues of the room (including reverberations, the sound absorption of different objects and materials, occlusions of the sound path, simultaneous speaking, and/or the like).

In some examples, prior to or at the beginning of the meeting or other event at which audio is being captured, devices carried by each participant, such as mobile phones, or other mobile devices of each participant, are synchronized with audio capture device 541. In some examples, the synchronization is achieved using Bluetooth or explicit pairing of the mobile phones and audio capture device 541 by other means.

In some examples in which mobile phones of each participant are synchronized with the device including audio capture device 541, at the beginning of the meeting, a signal is played from each of the phones, and then specific feedback is given to each participant, such as feedback as to whether the participant is located in an acoustically problematic location. For instance, in some examples, if it is determined that there is acoustical occlusion for a particular user, the user may be given feedback that the signal is being occluded and a recommendation may be given to the participant to move to a different location in order to improve the quality of the audio capture.

In some examples, during the meeting or other event in which audio is being captured, camera 571 records either an image or a video sequence that captures the relative location of speaker device 561 with respect to audio capture device 541. In some examples, detection of the faces of the human speakers is performed. In some examples, in which mobile phones of each participant are synchronized with the device that includes audio capture device 541, capturing the relative location of speaker device 561 with respect to the recording device may be achieved by detecting the faces of the human speakers and assuming that the mobile phones will be positioned in proximity to each human speaker.

The room-specific models may be used on the captured audio. For instance, in some examples, the audio may be recorded for later playback, with the audio recorded and processed via the room-specific models such that the audio is relatively clean, for example so that the speech in the played-back audio may be clearly understood. In some examples, the audio may be transmitted in real time, such that, using the room-specific models, the audio is transmitted such that the transmitted audio is relatively clean, for example so that speech of the transmitted audio may be clearly understood. In some examples, transcription is performed on speech in the audio using the room-specific models such that speech is accurately transcribed and accurate speech separation is performed such that the transcription accurately transcribes the words spoken by each human speaker and includes an accurate indication of which human speaker was talking for any speech in the captured audio. In this way, system boo may process the captured audio to provide an output, where the output may be recorded audio, transmitted audio, a speech transcription, a speech attribution, and/or the like, such that the output includes at least one adjustment of the captured audio based on at least one acoustical property of room 501.

FIG. 6 illustrates an example dataflow for a process (690) for audio capture. In some examples, process 690 is performed by a device, distributed system, or the like, such as, for instance, device 200 of FIG. 2, processing device(s) 341 of FIG. 3, processing device(s) 441 of FIG. 4, processing system 551 of FIG. 5, or the like.

In the illustrated example, step 691 occurs first. At step 691, in some examples, recorded sounds are received such that the sounds recorded were emitted from multiple locations in an environment and such that the sounds recorded are sounds that can be converted to room impulse responses. As shown, step 692 occurs next in some examples. At step 692, in some examples, the room impulse responses are generated from the recorded sounds. As shown, step 693 occurs next in some examples. At step 693, in some examples, location information that is associated with the multiple locations is received.

As shown, step 694 occurs next in some examples. At step 694, in some examples, at least the room impulses responses and the location information are used to generate at least one environment-specific model. As shown, step 695 occurs next in some examples. At step 695, in some examples, audio captured in the environment is received. As shown, step 696 occurs next in some examples. At step 696, in some examples, an output is generated by processing the captured audio with the at least one environment-specific model such that the output includes at least one adjustment of the captured audio based on at least one acoustical property of the environment. The process may then advance to a return block, where other processing is resumed.

### CONCLUSION

While the above Detailed Description describes certain examples of the technology, and describes the best mode contemplated, no matter how detailed the above appears in text, the technology can be practiced in many ways. Details may vary in implementation, while still being encompassed by the technology described herein. As noted above, particular terminology used when describing certain features or aspects of the technology should not be taken to imply that the terminology is being redefined herein to be restricted to any specific characteristics, features, or aspects with which that terminology is associated. In general, the terms used in the following claims should not be construed to limit the technology to the specific examples disclosed herein, unless the Detailed Description explicitly defines such terms. Accordingly, the actual scope of the technology encompasses not only the disclosed examples, but also all equivalent ways of practicing or implementing the technology.

We claim:

1. An apparatus, comprising:
at least one memory adapted to store run-time data, and at least one processor that is adapted to execute processor-executable code that, in response to execution, enables the apparatus to perform actions, including:
receiving recorded sounds, including sounds emitted from multiple locations in an environment;
in response to receiving the sounds emitted from the multiple locations in the environment, calculating room impulse responses from the recorded sounds;
determining location information that is associated with the multiple locations;
using the room impulses responses, the location information, and at least one clean speech recording to generate at least one environment-specific model;
receiving audio captured in the environment; and
generating an output by processing the captured audio with the at least one environment-specific model such that the output includes at least one adjustment of the captured audio based on at least one acoustical property of the environment.

2. The apparatus of claim 1, wherein the output is at least one of a speech transcription, a speech attribution, transmitted audio, or an audio recording.

3. The apparatus of claim 1, where the sounds are emitted from a human-mouth-simulating speaker.

4. The apparatus of claim 1, wherein the sounds are emitted from a speaker that is designed to simulate acoustical properties of a human mouth.

5. The apparatus of claim 1, wherein the at least one environment-specific model includes at least one of a noise suppression model, a speech enhancement model, a speech recognition model, or a speech separation model.

6. The apparatus of claim 1, wherein generating the at least one environment-specific model includes using machine learning to fine-tune a generic model that is not specific to a particular environment and that was generated based on machine learning.

7. The apparatus of claim 1, the actions further including, based at least on the room impulse responses, determining acoustically problematic locations in the environment.

8. The apparatus of claim 1, the actions further including:
causing mobile devices of meeting participants to generate a corresponding audible signal;
recording each of the audible signals generated by the mobile devices; and
based on the recorded audible signal signals, providing feedback to the participants in the meeting associated with, for each participant, whether that participant is located in an acoustically problematic location.

9. The apparatus of claim 1, wherein the emitted sounds are chirps that sweep through an audible frequency range associated with a dynamic range of a speaker exponentially over time.

10. The apparatus of claim 1, the actions further including coordinating the emission of the sounds from the multiple locations in the environment.

11. A method, comprising:
coordinating an emission of sounds from a plurality of locations in an environment such that the emitted sounds are sounds that can be used to determine room impulse responses;
receiving recordings of the emitted sounds;
calculating room impulse responses from the recorded sounds;
determining location information that is associated with the plurality of locations;
creating, using at least one processor, at least one environment-specific model using the room impulses responses and the location information;
receiving audio captured in the environment subsequent to creation of the environment-specific model; and
providing an output by processing the captured audio with the at least one environment-specific model such that the output includes at least one adjustment of the captured audio based on acoustics of the environment.

12. The method of claim 11, wherein the at least one environment-specific model includes at least one of a noise suppression model, a speech enhancement model, a speech recognition model, or a speech separation model.

13. The method of claim 11, wherein the emitted sounds are chirps.

14. The method of claim 11, wherein creating the at least one environment-specific model includes using machine learning to fine-tune a generic model that is not specific to a particular environment and that was generated based on machine learning.

15. The method of claim 11, wherein generating the at least one room-specific model is further based on a set of clean speech recordings.

16. A processor-readable storage medium, having stored thereon processor-executable code that, upon execution by at least one processor, enables actions, comprising:
receiving recorded sounds, including sounds recorded from emissions from multiple locations in a room;
in response to receiving the recorded sounds, calculating room impulse responses from the recorded sounds;
determining location information that is associated with the multiple locations;
generating at least one room-specific model based on at least the room impulses responses and the location information;
receiving audio captured in the room; and
providing an output by processing the captured audio with the at least one room-specific model such that the output includes at least one adjustment of the captured audio based on at least one aspect the room.

17. The processor-readable storage medium of claim 16, wherein the at least one room-specific model includes at least one of a noise suppression model, a speech enhancement model, a speech recognition model, or a speech separation model.

18. The processor-readable storage medium of claim 16, wherein the emitted sounds are chirps.

19. The processor-readable storage medium of claim 16, wherein generating the at least one room-specific model includes using machine learning to fine-tune a generic model that is not specific to a particular room and that was generated based on machine learning.

20. The processor-readable storage medium of claim 16, wherein generating the at least one room-specific model is further based on a set of clean speech recordings.
